(19) United States
(12) Patent Application Publication
(10) Pub. No.: US 2022/0034505 A1
(43) Pub. Date: Feb. 3, 2022

(54) PYROLYSIS SYSTEM AND METHOD OF USE

(71) Applicants: Gregory PULLAM, Calgary (CA); VARNEY Brian, Calgary (CA)

(72) Inventor: VARNEY Brian, Calgary (CA)

(21) Appl. No.: 17/275,630

(22) PCT Filed: Sep. 11, 2019
(86) PCT No.: PCT/CA2019/051287

§ 371 Date: Mar. 11, 2021

Related U.S. Application Data
(60) Provisional application No. 62/729,498, filed on Sep. 11, 2018.

(51) Int. Cl. F23G 5/027; C10B 53/07; F23G 5/10; F23G 5/44

(52) U.S. Cl. CPC F23G 5/0273; C10B 53/07; F23G 5/10; F23G 5/442; F23G 2900/50201; F23G 2204/204; F23G 2209/281; F23G 2205/121; F23G 2201/30

(57) ABSTRACT

A pyrolysis system and method of use is capable of continuously processing feedstock. The pyrolysis system has enclosed pyrolysis tubes heated by a heating means to pyrolyze feedstock. Conveying mechanisms such as augers transport the feedstock into and through the pyrolysis tubes. The pyrolysis tubes can be heated to a desired temperature range using a heat exchanger, such as a molten metal bath, or inductively heated using induction coils wrapped around the pyrolysis tubes. The feedstock is physically separated from the outside environment by the enclosed pyrolysis tubes. A dynamic feedstock plug is formed upstream of the pyrolysis tubes to prevent air and moisture from entering via the inlet of the pyrolysis tubes. An outlet section connected to the outlets of the pyrolysis tubes separates the gaseous and solid products of pyrolysis and permits removal of the products while preventing air and moisture from entering into the system.

### FIELD

Embodiments herein relate to systems for pyrolyzing materials. In particular, embodiments herein relate to a system and method for continuous-feed pyrolysis of feedstock materials such as plastic and rubber tires.

### BACKGROUND

Plastic waste is a major pressing environmental issue facing the world. It is estimated that 380 million tonnes of plastic products will be produced in 2018. Geyer, Jambeck, and Law estimate that, of the 8.3 billion tonnes of plastics produced, 6.3 billion tonnes have become plastic waste, of which only 9% has been recycled (“Production, use, and fate of all plastics ever made”, Science Advances, 19 Jul 2017, vol 3, no. 7). The vast majority of plastic waste is deposited in landfills or, worse still, accumulate in the environment as litter.

Rubber waste, such as that from discarded automobile tires, also poses a significant environmental problem, due to their non-biodegradablity, flammability, and chemical composition, which can result in the leaching of toxic substances into the ground when disposed of in landfills, or emission of toxic fumes upon incineration.

One effective method of recycling plastic and rubber waste is pyrolysis, which is the thermal decomposition of materials in an inert (i.e. substantially oxygen free) environment at high temperatures, for example 400-900° C. Pyrolysis is an attractive alternative to incineration or landfilling of waste plastics and rubber, as it generates fewer dioxins relative to incineration, while breaking down the material into reusable and saleable constituents, and does not present the leaching issues of landfilling.

The pyrolysis of plastic, rubber tires, and other feedstock produces condensable and non-condensable gases and char. As well as char, the process results in steel belting from the pyrolysis of tires. The condensable gases yield raw hydrocarbon constituents which can be further treated to produce valuable products, such as low-sulphur gasoline, diesel, and synthetic gas. The non-condensable gases are either incinerated or used as fuel, such as for power generation or to supply burners used in the pyrolysis process. In the case of the pyrolysis of plastics, gasoline and diesel derivatives are produced together with a waxy compound.

One conventional technology involves the use of heated kilns and/or molten metal bath (for example molten zinc) reactors to pyrolyze feedstock fed thereto. The advantage of a molten zinc bath reactor is that it provides for more efficient heat transfer to the feedstock than can be accomplished in a more traditional kiln environment due to the direct transfer of heat between the molten zinc and the feedstock, and thereby decreases the amount of time required to complete the pyrolysis process for a given amount of feedstock.

Used plastic and/or rubber tires are typically first shredded and dewatered, and then introduced into the kiln or molten zinc bath reactor in batches. The prior art's introduction of the feedstock in batches is necessary, as the kiln/reactor must be kept substantially free of air and water to prevent combustion and undesirable chemical reactions. For example, air and water can be removed from feedstock by passing it through a pre-feed chamber configured to remove air and water therefrom. The pre-feed chamber typically comprises doors at each of an upstream and downstream end of the chamber to allow feedstock to enter and leave the chamber while preventing air and water from entering the pyrolysis reactor/kiln. The first door located at the upstream end of the pre-feed chamber is opened periodically to receive feedstock material, while the second door located adjacent the downstream end is closed to isolate the reactor/kiln from the chamber. Once the feedstock has entered the pre-feed chamber, the first door is closed to isolate the pre-feed chamber from upstream components. Air and water are then purged out of the pre-feed chamber by filling the chamber with an inert gas, such as nitrogen, while the first and second doors remain closed. Once air and water have been removed from the feedstock and pre-feed chamber, the second door is opened to allow the air-and-water-free feedstock to enter the reactor/kiln for pyrolysis, while the first door remains closed. The pre-feed chamber used in current technology necessitates in an intermittent feed process where feedstock is pyrolyzed in batches. Additionally, the current technology requires the use of an inert purge gas such as nitrogen, which introduces complexity into the pyrolysis process and adds cost.

Products of pyrolysis such as char and other solid residue must also be periodically removed from the kiln/molten metal bath reactor to create room for additional feedstock and mitigate contamination of the molten metal, which may affect the efficiency of the pyrolysis process. Such removal of residue also necessitates interruption of the pyrolysis process, as the interior of the kiln/reactor must be accessed to remove residue therefrom.

The pyrolysis process is interrupted each time a new batch of feedstock is introduced, or whenever particulate residue is removed from the kiln/bath. There exist methods for efficiently introducing batches of feedstock into the kiln or molten zinc bath reactor, and for the removal of solid or particulate residue therefrom. However, such methods still do not enable a continuous pyrolysis process, wherein feedstock is more preferably and continuously introduced into the system and pyrolyzed, and/or residue and other products of pyrolysis are continuously removed.

The current challenge with pyrolysis of feedstock such as plastics and/or rubber tires has been in the development of a system and method that will allow for the introduction of feedstock into the pyrolysis process, and the removal of any particulate residue from the kiln or reactor, in a continuous manner so as not to interrupt the pyrolysis process. Allowing the pyrolysis to proceed without any interruption will make the process more economical, as the rate of pyrolysis of feedstock can be increased.

There is a need for a system and method that provides for the continuous introduction of feedstock into a kiln or reactor for pyrolysis, and continuous removal of pyrolysis products and residue therefrom.

### SUMMARY

In a broad aspect, a pyrolysis system for pyrolyzing feedstock can comprise a feed section having a conveyor configured to receive the feedstock and transport it towards a downstream pyrolysis section having one or more pyrolysis tubes. The pyrolysis tubes are configured to receive the feedstock from the feed section and are heated using at least one heat source. The heat is transferred to the feedstock for pyrolyzing the feedstock within the one or more pyrolysis tubes. The pyrolysis tubes are substantially enclosed except at its inlet and outlet ends, such that feedstock and the products of pyrolysis must exit via the outlet end. A constriction located between the feed section and pyrolysis section consolidates the feedstock and removes water and air therefrom before it enters the pyrolysis section. An outlet section is located downstream of the pyrolysis section for separating gases and residual solids produced from the pyrolysis of the feedstock. In operation, the feedstock is continuously fed into the pyrolysis system, transported by the conveyor to the pyrolysis section, pyrolyzed inside the pyrolysis tubes by the at least one heat source, and the products of pyrolysis are continuously removed from the pyrolysis system via the outlet section.

In embodiments, the heat source is a liquid heat exchange medium. In embodiments, the heat exchange medium is a liquid molten metal bath. In other embodiments, the heat source is induction coil heating.

In embodiments, multiple pyrolysis tubes arranged in parallel and can incorporate augers therein for conveyance of feedstock.

In a general aspect, a pyrolysis system for the continuous pyrolysis of feedstock and removal of products of the pyrolysis of feedstock to downstream equipment comprises one or more pyrolysis tubes configured to receive feedstock from one or more conveyors; heating means for heating the one or more pyrolysis tubes and pyrolyzing the feedstock therein; and an outlet section for receiving and directing the products of pyrolysis to the downstream equipment; wherein the pyrolysis tubes are substantially enclosed to prevent the feedstock and products of pyrolysis from leaving the pyrolysis tubes except via the outlet section.

In an embodiment, the one or more conveyors each have a first stage auger extending therethrough and operatively connected to a first drive mechanism configured to rotate the first stage auger for conveying the feedstock towards the one or more pyrolysis tubes.

In an embodiment, the pyrolysis system further comprises one or more second stage augers extending through a respective one of the one or more pyrolysis tubes and operatively connected to a respective second drive mechanism configured to rotate the second stage auger for conveying the feedstock through the one or more pyrolysis tubes towards the outlet section.

In an embodiment, the one or more conveyors each comprise a radial constriction located towards an outlet end of the one or more conveyors for consolidating the feedstock and forcing air and water out therefrom.

In an embodiment, the heating means comprises a heat exchanger having a heat exchange medium stored in a heat exchange chamber; one or more heat sources are configured to heat the heat exchange medium; and the one or more pyrolysis tubes are at least partially immersed in the heat exchange medium for receiving heat therefrom.

In an embodiment, the one or more pyrolysis tubes are made at least partially of a ferromagnetic material; and the heating means comprises one or more induction coils wrapped around each of the one or more pyrolysis tubes and operatively connected to at least one AC power source configured to deliver a driving alternating current thereto for heating the one or more induction coils.

In an embodiment, the outlet section comprises a gas conduit for receiving gases of the products of pyrolysis and a solids collection portion for receiving solid residue of the products of pyrolysis.

In an embodiment, the gas conduit comprises a one-way valve for permitting gases of the products of pyrolysis to exit the pyrolysis system while maintaining the substantially inert environment of the pyrolysis section; and the solids collection portion comprises a solids removal valve for permitting the solid residue to be removed while maintaining the substantially inert environment of the pyrolysis section.

In another general aspect, a pyrolysis apparatus for the continuous pyrolysis of feedstock and removal of products of the pyrolysis of feedstock to an outlet section comprises one or more pyrolysis tubes configured to receive feedstock at an inlet end and direct the products of pyrolysis to the outlet section via an outlet end; and heating means for heating the one or more pyrolysis tubes and pyrolyzing the feedstock therein; wherein the pyrolysis tubes are substantially enclosed except at the inlet end and outlet end.

In an embodiment, the heating means comprises a heat exchanger having a heat exchange medium stored in a heat exchange chamber; one or more heat sources are configured to heat the heat exchange medium; and the one or more pyrolysis tubes are at least partially immersed in the heat exchange medium for receiving heat therefrom.

In an embodiment, the heat exchange medium is a molten metal.

In an embodiment, the pyrolysis apparatus further comprises an inert gas stored in the heat exchange chamber for mitigating oxidation of the molten metal.

In an embodiment, the one or more pyrolysis tubes are made at least partially of a ferromagnetic material; the heating means comprises one or more induction coils wrapped around each of the one or more pyrolysis tubes and operatively connected to at least one AC power source configured to deliver a driving alternating current thereto for inductive heating of the one or more induction coils.

In an embodiment, each of the one or more pyrolysis tubes have at least two induction coils of the one or more induction coils wrapped therearound, and each of the at least two induction coils are connected to a respective AC power source.

In an embodiment, each of the at least two pyrolysis tubes are axially separated by a thermal and magnetic insulator.

In another general aspect, a method of continuously pyrolyzing feedstock and directing products of the pyrolysis of feedstock to an outlet section comprises receiving feedstock in one or more pyrolysis tubes; preventing the feedstock and products of pyrolysis from leaving the pyrolysis tubes except via the outlet section; and heating the one or more pyrolysis tubes to within a desired temperature range, for the feedstock, for pyrolyzing the feedstock therein.

In an embodiment, the method further comprises permitting gases of the product of pyrolysis to exit via a gas conduit of the outlet section while preventing air and moisture from entering into the one or more pyrolysis tubes.

In an embodiment, the method further comprises removing solid residue of the products of pyrolysis from the outlet section while preventing air and moisture from entering into the one or more pyrolysis tubes.

In an embodiment, the method further comprises compressing the feedstock to form a plug upstream of the one or more pyrolysis tubes for preventing air and moisture from entering into the one or more pyrolysis tubes.

In an embodiment, the method further comprises heating axial segments of each of the one or more pyrolysis tubes to a different temperature.

### BRIEF DESCRIPTION OF THE DRAWINGS

FIG. 1 is a cross-sectional side view of an embodiment of a pyrolysis system that utilizes a molten metal bath as a heating means;

FIG. 2A is a cross-sectional side view of an alternative embodiment of a pyrolysis system that incorporates induction coils as a heating means;

FIG. 2B is a cross-sectional side view of an alternative embodiment of a pyrolysis system that incorporates multiple pyrolysis tubes arranged in series with induction coils as a heating means;

FIG. 3A is an isometric view of an embodiment of a pyrolysis tube of a pyrolysis system that incorporates induction coils connected in parallel for inductive heating of the pyrolysis tube;

FIG. 3B is a side view of an insulator of the pyrolysis system of FIG. 3A along cut line A-A;

FIG. 3C is a cross sectional front view through the insulator shown in FIG. 3B along cut line B-B;

FIG. 3D is an isometric view of an embodiment of a pyrolysis tube of a pyrolysis system that incorporates induction coils connected in series for inductive heating of the pyrolysis tube;

FIG. 4A is a partial cross-sectional side view of a configuration of a feedstock conveying auger of a pyrolysis system;

FIG. 4B is a partial cross-sectional side view of an alternative configuration of a feedstock conveying auger of a pyrolysis system;

FIGS. 4C, 4D, 4E and 4F are cross sectional front views of the conveying auger of FIG. 4B along cut line C-C depicting one, two, three and four-vane configurations, respectively;

FIG. 5A is a cross-sectional top view of an embodiment of a pyrolysis system with a molten metal bath heating means comprising multiple feedstock streams each comprising individual feedstock source, conveyors, and pyrolysis tubes;

FIG. 5B is a cross-sectional side view of a pyrolysis stream of the pyrolysis system of FIG. 5A;

FIG. 5C is a cross-sectional top view of an embodiment of a pyrolysis system with a molten metal bath heating means comprising a common feedstock source and conveyor configured to convey feedstock to multiple pyrolysis streams via a distribution manifold;

FIG. 5D is a cross sectional front view of the pyrolysis system of FIG. 5C along cut line E-E depicting an embodiment of the distribution manifold with multiple outlets distributed in a circular formation;

FIG. 5E is a cross sectional front view of the pyrolysis system of FIG. 5C along cut line E-E in an alternative embodiment, depicting an embodiment of the distribution manifold with multiple outlets distributed in a linear formation;

FIG. 6A is a cross-sectional top view of an embodiment of a pyrolysis system with induction coil heating means comprising multiple feedstock streams each comprising individual feedstock source, conveyors, and pyrolysis tubes;

FIG. 6B is a cross-sectional side view of a pyrolysis stream of the pyrolysis system of FIG. 6A;

FIG. 6C is a cross-sectional top view of an embodiment of a pyrolysis system with induction coil heating means comprising a common feedstock source and conveyor configured to convey feedstock to multiple pyrolysis streams via a distribution manifold;

FIG. 6D is a cross sectional front view of the pyrolysis system of FIG. 6C along cut line F-F depicting an embodiment of the distribution manifold with multiple outlets distributed in a circular formation; and

FIG. 6E is a cross sectional front view of the pyrolysis system of FIG. 6C along cut line F-F in an alternative embodiment, depicting an embodiment of the distribution manifold with multiple outlets distributed in a linear formation.

### DESCRIPTION

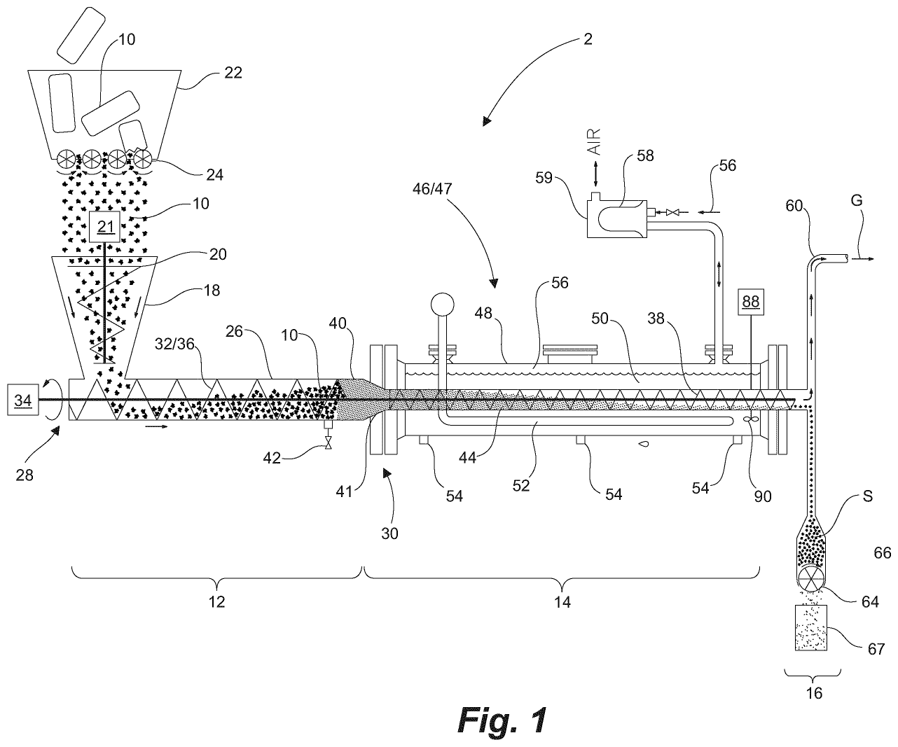

With reference to FIG. 1, an improved pyrolysis system and method of use is disclosed herein for providing a continuous process for the pyrolysis of feedstock 10 such as plastic and rubber tires. In an embodiment, the system improves upon known pyrolysis systems, such as those using a heated kiln or a molten metal bath reactor to pyrolyze feedstock 10. The disclosed system comprises a feed section 12 for preparing and transporting feedstock 10, a pyrolysis section 14 for pyrolyzing the feedstock 10 delivered thereto by the feed section 12, and an outlet section 16 for directing the products of pyrolysis for downstream processing or disposal. The pyrolysis section 14 comprises one or more enclosed pyrolysis tubes 44 heated by a heating means 46 to pyrolyze the feedstock 10 therein. In one embodiment, the pyrolysis tubes 44 are at least partially immersed in, or otherwise in contact with, a heat exchange medium 50 in a heat exchanger 47, such as a molten metal bath, which is maintained within a desired temperature range by one or more heat sources 52 to pyrolyze the feedstock 10. The feedstock 10 is physically separated from the heat exchange medium 50 by the enclosed pyrolysis tubes 44, such that the products of pyrolysis must exit the pyrolysis section 14 towards the outlet section 16, and contrary to the prior art, the heat exchange medium 50 need not be periodically cleaned of pyrolysis products. In other embodiments, the heating means 46 comprise induction coils 70 wrapped around the pyrolysis tubes 44 and configured to heat the pyrolysis tubes 44 via electromagnetic induction to a desired temperature range and pyrolyze the feedstock 10 therein.

In embodiments, the pyrolysis system 2 is generally horizontally oriented, such that, while there may be inclined portions of the system 2, the feedstock 10 proceeds generally horizontally from the feed section 12 through the pyrolysis section 14 and into the outlet section 16.

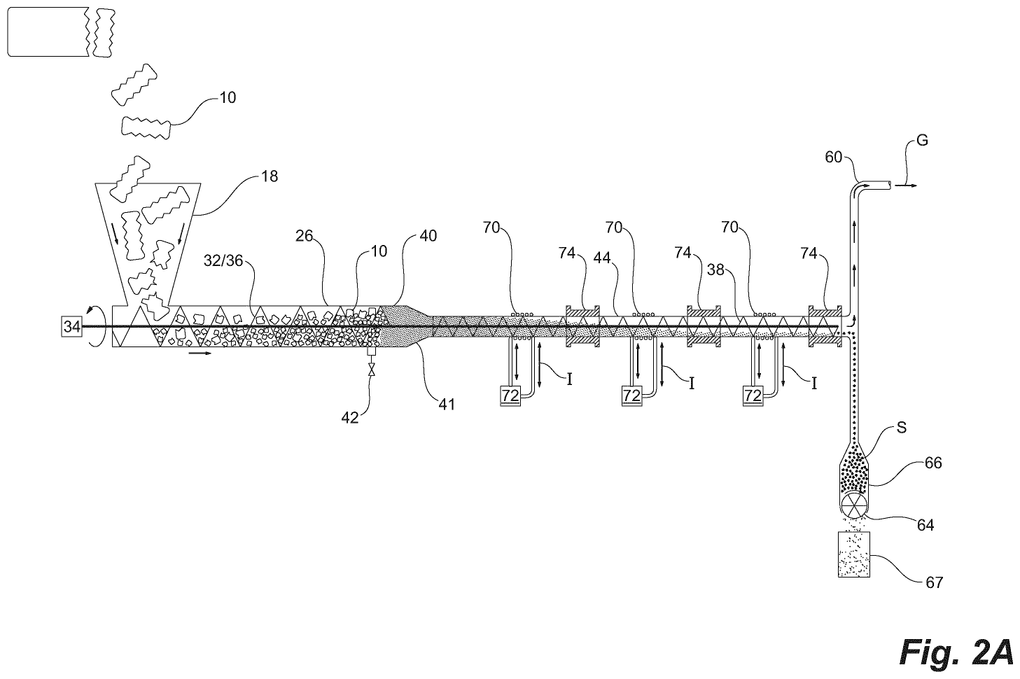

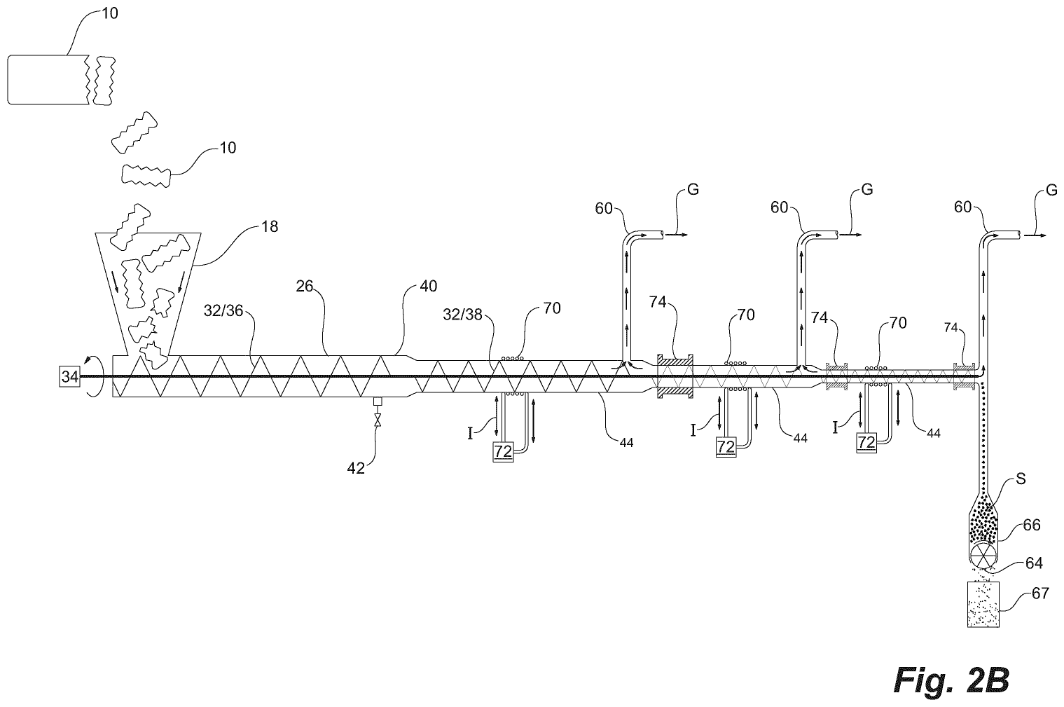

With reference to FIGS. 1 and 2A, as discussed above, embodiments of the improved pyrolysis system 2 disclosed herein comprise a feed section 12, a pyrolysis section 14, and an outlet section 16. The feed section 12 comprises a feed hopper 18 that is configured to receive feedstock 10 and direct it to a first end 28 of a conveyor 26 operable to deliver feedstock 10 into each pyrolysis section 14. The feed hopper 18 can also have an active feeding mechanism 20, such as an auger driven by a feed hopper motor 21, to consolidate and force the feedstock 10 into the conveyor 26.

In embodiments, the feedstock 10 can be prepared before being loaded into the feed hopper 18, such as by shredding, grinding, and otherwise being broken down to smaller pieces for ease of conveyance and more efficient heat transfer thereto during pyrolysis. In order to more effectively pyrolyze tires, the tires can be shredded into “crumbs” so that they will fit inside the various components of the pyrolysis system 2. For example, with reference to FIG. 1, a shredding hopper 22 can be configured to break down feedstock 10 and deliver it to the feed hopper 18. A shredding mechanism 24, such as a plurality of crushing/shredding rollers, can be positioned in the shredding hopper 22 and operate to break feedstock 10 into smaller particles before it is transported further downstream in the pyrolysis system 2. The breaking down of feedstock 10 accomplishes three functions: 1) dewatering the feedstock 10, 2) removing debris therefrom, and 3) preparing the feedstock 10 for pyrolysis.

In the embodiment depicted in FIGS. 1 and 2A, the conveyor 26 is a generally tubular member housing a conveying mechanism 32 therein, such as an auger. The conveying mechanism 32 is operable to convey feedstock 10 towards the pyrolysis section 14. Herein, the conveying mechanism 32 comprises an auger. However, a person of skill in the art would understand any suitable conveying mechanism 32 may be used in place of an auger, such as a hydraulic ram, and the like. The conveyor 26 is configured to receive feedstock 10 from the feed hopper 18 at its first end 28, and is in communication with the pyrolysis section 14 at an outlet or second end 30. A first stage auger 36 of the conveying mechanism 32 is configured to convey the feedstock 10 received from the feed hopper 18 into the pyrolysis section 14. A conveyor drive mechanism 34, such as an electric motor, is operatively coupled with the conveying mechanism 32 and configured to drive the first stage auger 36 to transport feedstock 10 through the conveyor 26 towards the pyrolysis section 14. The first stage auger 36 can also be configured to consolidate the feedstock 10 and expel any water and/or air entrained therein as it is transported towards the pyrolysis section 14. For example, reducing the pitch of the first stage auger 36 towards the second end 30 of the conveyor 26 will cause the feedstock 10 near the second end 30 to be compressed by the incoming feedstock 10 conveyed thereto by the first stage auger 36. In embodiments, the first stage auger 36 can terminate adjacent the outlet end 30 of the conveyor 26, at a distance from the entrance to the pyrolysis section 14.

The outlet end 30 of the conveyor 26 can have a feedstock consolidation means 40, such as a radial constriction/nozzle, configured to compress feedstock 10 passing therethrough. Such compression forces out residual water and/or air within the feedstock 10 and consolidates the feedstock 10 before it enters the pyrolysis section 14. In one aspect, it is desirable to remove water and air from the feedstock 10 to maintain a substantially inert environment within the downstream pyrolysis section 14 for more effective pyrolysis. Water and air removed from the feedstock 10 flows back towards the first end 28 of the conveyor 26 and can be evacuated via one or more removal ports 42 located upstream of the radial constriction/nozzle 40. Further, the compressed feedstock 10 forms a feedstock plug/door 41 that prevents air and moisture from entering into the one or more pyrolysis tubes 44 downstream, thus helping to maintain an inert environment therein.

Referring still to FIGS. 1 and 2A, a second stage auger 38 of the conveying mechanism 32 can be located in each tube 44 of the pyrolysis section 14, such as downstream from the radial constriction/nozzle 40, to convey feedstock 10 through the pyrolysis section 14, and the products of pyrolysis towards the outlet section 16. The second stage auger 38 also axially and circumferentially distributes the feedstock 10 such that it is more evenly exposed to the heat of the pyrolysis section 14. In the embodiments depicted in FIGS. 1 and 2A, implementing one pyrolysis tube 44, the radius of the second stage auger 38 is smaller relative to the first stage auger 36 due to the radial constriction/nozzle 40. However, such a reduction in the radius of the second stage auger 38 is not strictly necessary. For example, if a feedstock consolidation means 40 other than a radial constriction is used to substantially remove water and from the feedstock 10, or if the radial constriction/nozzle 40 is only temporary, the second stage auger 38 can have the same or a greater radius than the first stage auger 36.

The pyrolysis section 14 comprises one or more pyrolysis tubes 44 configured to receive feedstock 10 from the feed section 12. The pyrolysis tubes 44 are heated to within a desired temperature range using a heating means 46 to pyrolyze the feedstock 10 therein. It may be desirable to pyrolyze feedstock 10 within multiple pyrolysis tubes 44 as opposed to a single large pyrolysis tube 44 or kiln, as the multiple pyrolysis tubes 44 present a greater surface-area-to-unit-volume compared to a single pyrolysis tube 44 of the same volume, thus providing for more efficient heat transfer to the feedstock 10 therein. The pyrolysis tubes 44 are substantially enclosed, such that the only points of ingress and egress are at the inlets and outlets of the pyrolysis tubes 44, respectively. Confining the feedstock 10 within the pyrolysis tubes 44 along the entire length of the pyrolysis section 14 is advantageous, as the products of pyrolysis such as gases G and solid residue S are all displaced out the outlet end of the pyrolysis tubes 44 on a continuous basis as new feedstock 10 is introduced.

In an embodiment illustrated in FIG. 1, the heating means 46 is a heat exchanger 47, wherein the pyrolysis tubes 44 are housed in a heat exchange/bath chamber 48 at least partially filled with a heat exchange medium 50, for example a molten metal such as molten zinc or another suitable molten material, such that the pyrolysis tubes 44 are at least partially in contact with the heat exchange medium 50. In some embodiments, the pyrolysis tubes 44 are completely submerged in the heat exchange medium 50. For convenience, the heat exchange medium 50 will be referred to as a molten metal. As depicted in FIG. 1, the heat exchanger 47 has a configuration similar to a shell-and-tube heat exchanger.

The heat exchanger 47 further comprises at least one heat source 52, such as an electric heater or burners, configured to heat the molten metal heat exchange medium 50 within the heat exchange/bath chamber 48 to the desired temperature range. Preferably, the heat source 52 is located toward the bottom of the heat exchange/bath chamber 48 so as to take advantage of convection currents to circulate and more evenly heat the molten metal heat exchange medium 50. In embodiments, a circulation mechanism 88, such as a circulation propeller 90 or similar device, can be located within the heat exchange/bath chamber 48 to more deliberately circulate the molten metal heat exchange medium 50 for more even heat distribution. One or more thermocouples 54 can be located in the heat exchange/bath chamber 48 to measure the temperature of the molten metal 50 heat exchange medium. In some embodiments, the pyrolysis tubes 44 can be made of steel or similar material with a ceramic coating to resist corrosion caused by the molten metal 50 heat exchange medium.

As shown in FIG. 1, the interior of the heat exchange/bath chamber 48 can also be filled with an inert gas 56 such as nitrogen (N2) to create an inert gas 56, or blanket, that excludes air and oxygen from entering into the heat exchange/bath chamber 48, thus mitigating oxidation of the molten metal heat exchange medium 50 and other components in the heat exchange/bath chamber 48. An expandable gas bladder 58 housed in a gas expansion vessel 59 can be in communication with the interior of the heat exchange/bath chamber 48 to accommodate thermal expansion of the inert gas 56 and maintain the inert gas 56 blanket despite variations in pressure and temperature of the heat exchange/bath chamber 48.

As stated above, in embodiments, a second stage auger 38 can be located in each of the pyrolysis tubes 44 to convey feedstock 10 therethrough. The second stage auger 38 can be connected to, and in-line with, the first stage auger 36 so as to be driven by the same drive mechanism 34. In other embodiments, the second stage auger 38 can be radially spaced from the first stage auger 36 and driven by its own respective drive mechanism 34, or a common second stage drive mechanism 34, such as when multiple pyrolysis tubes 44 are configured to receive feedstock 10 from the feed section 12. For example, second stage augers 38 can extend from the outlet section 16 into each of the pyrolysis tubes 44, and the drive mechanisms 34 can be located toward the outlet ends of the pyrolysis tubes 44. High temperature and low pressure shaft seals can be incorporated at the point at which the second stage augers 38 pass into the outlet ends of the pyrolysis tubes 44. Gases G and particulate matter S produced from the pyrolysis of feedstock 10 are directed by the second stage augers 38 towards the outlet end of the pyrolysis tubes 44, which is in communication with the outlet section 16.

The outlet section 16 can comprise a gas conduit 60 and a solids collection portion 62. The gas conduit 60 is located towards an upper portion of the outlet section 16 and directs the evolved hot condensable and non-condensable gases G produced during the pyrolysis process to downstream equipment, such as cyclone separators, condensers, and the like (not shown), which process the evolved gases and separate any particulate matter that may have been carried therewith. These gases can be cooled to separate the non-condensable portion of the gases from the condensable gases. Non-condensable gases can be used to supplement fuel used by heat source 52 to heat the heat exchange/bath chamber 48, or can be incinerated or otherwise disposed of. The condensable gases can be processed further to produce commercial products such as low-sulphur gasoline, diesel gas, and synthetic gas. In some embodiments, a one-way valve, such as a check valve, can be located along the gas conduit 60 and configured to permit gases to exit the outlet section 16 towards downstream equipment, but prevent air from entering the outlet section 16 therethrough to maintain a substantially inert environment in the pyrolysis tubes 44. The solids collection portion 62 is located towards a lower portion of the outlet section 16 and is configured to receive particulates and other solid residue S produced by the pyrolysis process, such as in a collection chamber 66. The solids collection portion 62 can have a solids removal valve 64 configured to allow solid residue to be removed therefrom, such as into solids receptacle 67, for processing or disposal, while preventing air from entering the outlet section 16 therethrough to maintain a substantially inert environment in the pyrolysis tubes 44. For example, the solids removal valve 64 could be a rotary valve that functions as an airlock.

### Inductive Heating

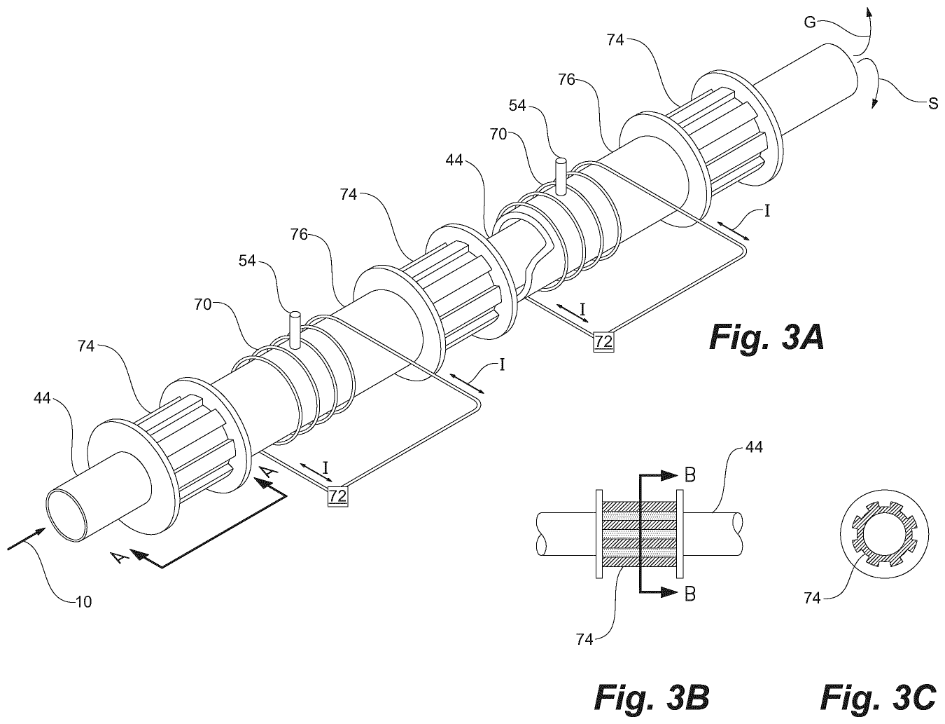

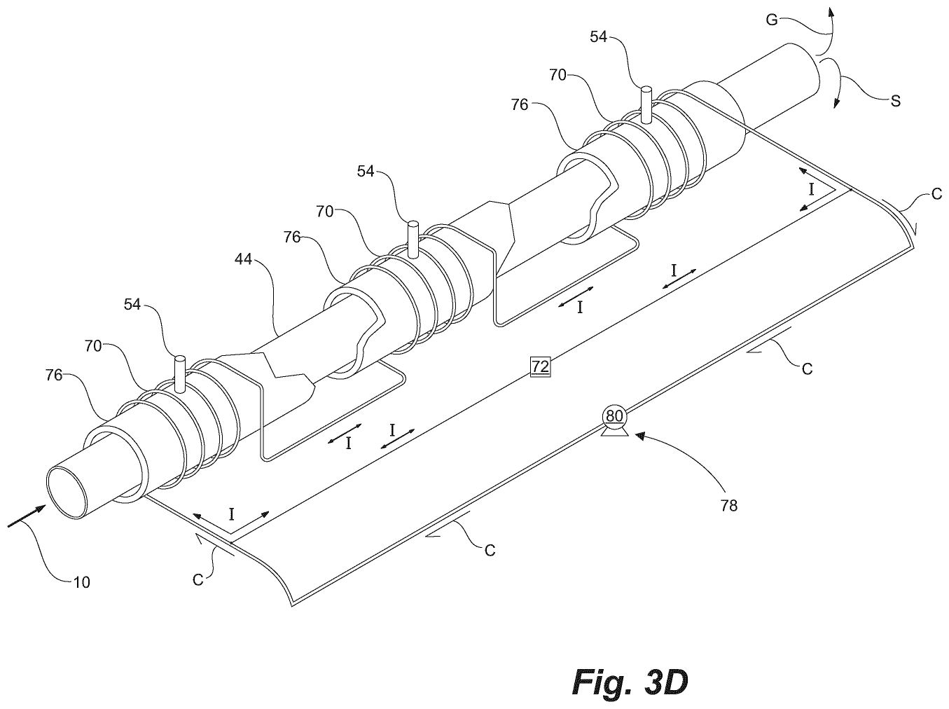

In an alternative embodiment, with reference to FIGS. 2A-3D, the heating means 46 comprises one or more induction coils 70 configured to inductively heat the pyrolysis tubes 44, the second stage augers 38, or both to pyrolyze the feedstock 10. In such embodiments, one or more induction coils 70 can be located coaxially with the pyrolysis tubes 44 and coiled therearound. The induction coils 70 are connected to an AC power source 72 configured to provide a driving alternating current I thereto. The induction coils 70 can be connected to a common AC power source 72, groups of induction coils 70 can be connected to a common AC power source 72, or each individual induction coil 70 can be connected to its own AC power source 72. The induction coils 70 can be electrically connected in parallel (FIG. 3A), or in series (FIG. 3D). The number of windings of each induction coil 70 can also vary depending on the requirements of the pyrolysis process.

The pyrolysis tubes 44 and/or the second stage augers 38 therein are made at least partially of a ferromagnetic material, for example steel, such that the magnetic field created by the driving electrical alternating current I flowing through the induction coils 70 generates an induced electrical alternating current in the pyrolysis tubes 44 and/or the second stage augers 38, thereby heating the pyrolysis tubes 44 and second stage augers 38 via induction heating. The induction coils 70 need not be in contact with the tubes 44 to generate and transmit heat thereto.

The number of induction coils 70 that are positioned around each pyrolysis tube 44 can depend upon the nature of the feedstock 10 to be pyrolyzed and the feed rate required for compete pyrolysis of the feedstock 10 to occur. For example, the number of induction coils 70, the coil configuration and/or the required heat input for pyrolysis are a function of the type of feedstock 10, the mass flow rate (i.e. feed rate) of the incoming feedstock 10, the specific heat capacity of the feedstock 10, the temperature differential between the feedstock 10 and the optimum pyrolysis temperature and/or optimum heating rate, as well as, the thermal/electrical conductivity of the pyrolysis tubes 44. The amount of induction heating available is a function of the number of induction coils 70, the current carrying capacity of the coils, the frequency of the alternating current power source and the amount of current and voltage being applied to the induction coils 70. The actual length of the pyrolysis tubes and the number of induction coils 70 and coil configuration will then be determined accordingly. Typically, the higher the feed rate, the more induction heating (i.e. induction coils) will be required.

In embodiments, the temperature along a pyrolysis tube 44 can be varied by utilizing multiple induction coils 70 axially spaced along the pyrolysis tube 44, each induction coil 70 connected to a corresponding AC power source 72. The induction coils 70 of a pyrolysis tube 44 can be thermally and magnetically isolated from adjacent induction coils 70 by a thermal/magnetic insulator 74, such as a ceramic insulator. Each AC power source 72 can provide a driving alternating current I of differing frequency, current, or voltage to its respective induction coil 70 to heat portions of the pyrolysis tube 44 corresponding to the induction coils 70 to different temperatures. Managing the heating of the pyrolysis tubes 44 in this manner provides greater control over, and improves the efficiency of, the pyrolysis process by allowing for variable and selectable pyrolysis temperatures along the length of each pyrolysis tube 44 for optimal pyrolysis of the feedstock 10. For example, the induction coils 70 closer to the inlet of a pyrolysis tube 44 can be configured to heat the pyrolysis tube 44 to a higher temperature to rapidly heat the feedstock 10 as it enters the pyrolysis tube 44, while induction coils 70 closer to the outlet can be configured to heat the pyrolysis tube 44 to relatively lower temperatures to maintain the temperature of the feedstock 10 therein, thereby optimizing the pyrolysis of the feedstock 10. The same effect could be achieved by adjusting the number of windings of the induction coils 70 connected in series to vary the density of the heating.

A reverse heating configuration can also be implemented to provide for a more gradual heating of the feedstock 10. In some embodiments, the second stage augers 38 can have ceramic insulator segments 77 juxtaposed to the thermal/magnetic insulators 74 (see FIGS. 1 to 3C), such that segments of the second stage augers 38 are thermally and magnetically isolated and can also be heated up to different temperatures by corresponding induction coils 70.

The inductive heating described above generates heat for the pyrolysis process directly in the pyrolysis tubes 44 and, in embodiments, also in the second stage auger 38, as opposed to the more indirect form of requiring heat to be transferred from the heat sources 52 to the heat exchange medium 50, by conduction from the heat exchange medium 50 to the pyrolysis tubes 44, and finally from the pyrolysis tube 44 to the feedstock 10, with losses occurring at each step. Direct heating of the pyrolysis tubes 44 via induction eliminates the need for an intermediate heat exchange medium 50 such as molten metal or hot gases, and heats the feedstock 10 from the outside via the pyrolysis tubes 44 as well as the inside via the auger 38. The above-described inductive heating allows for more efficient transfer of heat to the feedstock 10 than that afforded by prior art heating technologies, due to fewer losses occurring in the conversion of electrical energy supplied to the induction coils 70 to heat in the pyrolysis tubes 44 and augers 38, relative to the conduction of heat from a heat source 52 to the pyrolysis tubes 44 via a heat exchange medium 50.

In embodiments, as shown in FIG. 3D, a cooling system 78 can be utilized to actively maintain the induction coils 70 within an ideal operating temperature range. For example, the induction coils 70 can be hollow, and a coolant pump 80 can be configured to circulate coolant C through the induction coils 70.

In order to increase the thermal efficiency of the heating process, an insulation layer 76, such as a layer of calcium silicate or insulating ceramic, may be installed between the pyrolysis tubes 44 and the induction coils 70. Such an insulation layer 76 will not only provide insulation to minimize heat loss back out from the pyrolysis tubes 44 toward the feed section 12, but it will also keep the induction coils 70 from being heated themselves by the radiant heat emanating from the pyrolysis tubes 44, thereby reducing the amount of cooling water that will be required to keep the induction coils 70 sufficiently cool. In embodiments, the insulation layer 76 can be applied to, or wrapped around, the surface of the pyrolysis tubes 44. In other embodiments, the insulation layer 76 can be applied to, or wrapped around, the induction coils 70.

Thermocouples 54 can be located at various locations on the pyrolysis tubes 44 to measure the temperature thereof, such that an operator can ensure that each section of the pyrolysis tubes 44 is maintained within a desired temperature range for pyrolysis.

### Multiple Pyrolysis Streams

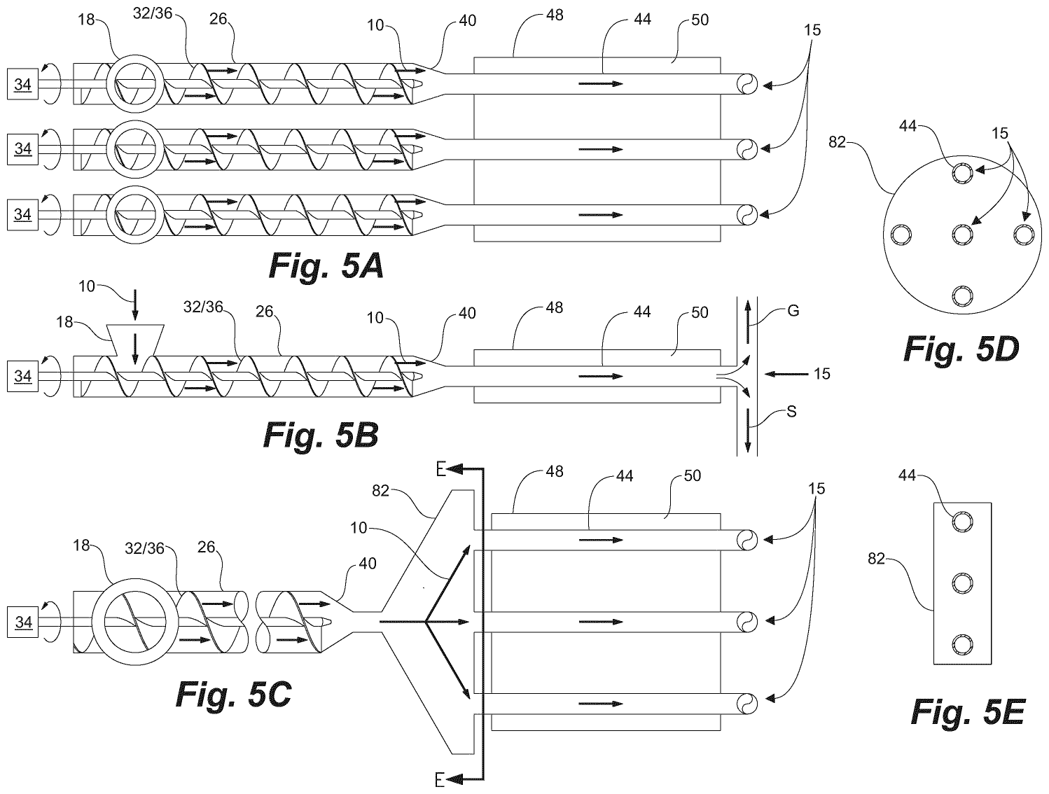

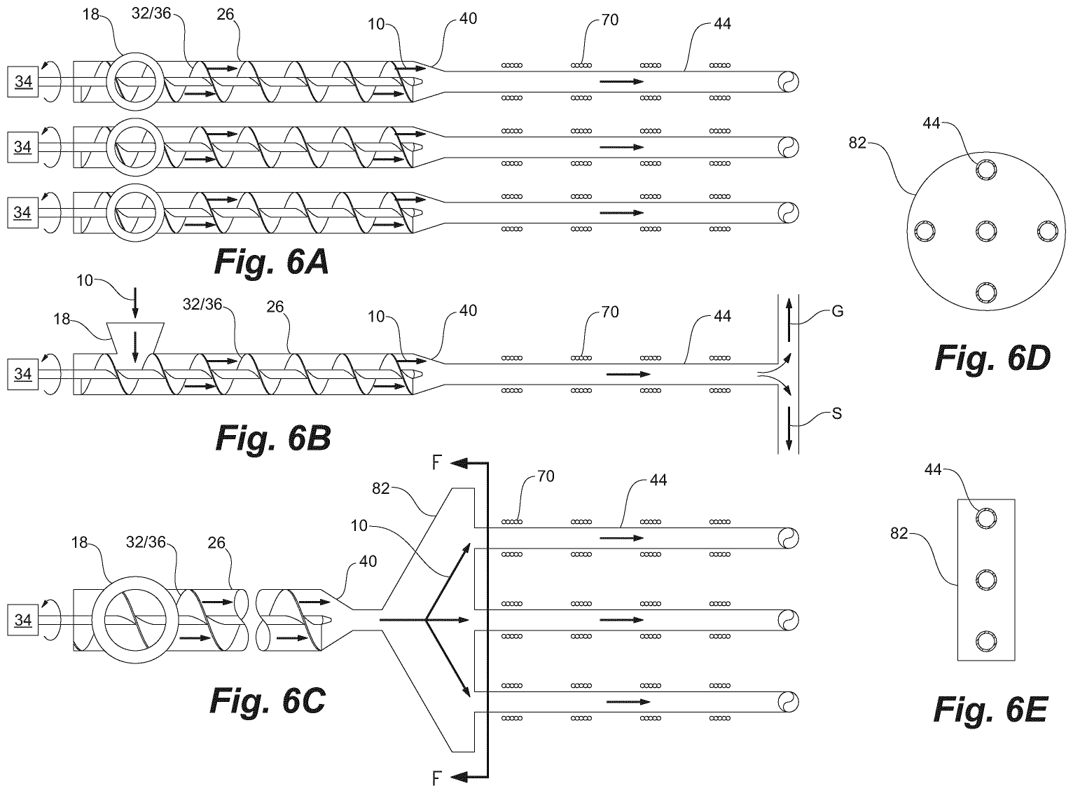

FIGS. 5A and 5B depict a pyrolysis system 2 having multiple independent pyrolysis streams 15. Each stream 15 comprises a heated pyrolysis tube 44 into which feedstock 10 is introduced from a corresponding conveyor 26 housing a first stage auger 36. As shown, one molten metal bath heat exchange medium 50 in a heat exchange/bath chamber 48 can be used to heat all of the pyrolysis tubes 44. In other embodiments, multiple heat exchange/bath chambers 48 may be used. In the embodiment depicted in FIGS. 5A and 5B, no second stage auger 38 is used, and the feedstock 10 in the pyrolysis tubes 44 is displaced towards the outlet section 16 by the incoming feedstock 10 conveyed into the pyrolysis tubes 44 by the first stage auger 36. Of course, a second stage auger 38 could be used to assist in conveying feedstock 10 through the pyrolysis tubes 44 and pyrolysis products towards the outlet section 16. FIGS. 6A and 6B depict a similar pyrolysis system 2, except the pyrolysis tubes 44 are heated by induction coils 70.

FIG. 5C shows a pyrolysis system 2 having a single conveyor 26 delivering feedstock 10 to multiple pyrolysis streams 15 in communication therewith via a distribution manifold 82. Each stream 15 comprises a pyrolysis tube 44 heated by a molten metal bath heat exchange medium 50 , into which feedstock 10 is introduced from the common conveyor 26 via the distribution manifold 82. As with the embodiment shown in FIGS. 5A and 5B, one heat exchange/bath chamber 48 can be used to heat all of the pyrolysis tubes 44, or multiple heat exchange/bath chambers 48 can be used. FIG. 6C depicts a similar pyrolysis system, except the pyrolysis tubes 44 are heated by induction coils 70. FIGS. 5D and 6D illustrate a cross-section of a circular distribution manifold 82 with openings to direct feedstock 10 to five (5) pyrolysis tubes 44. FIGS. 5E and 6E show a cross-section of a rectangular distribution manifold 82 with openings to direct feedstock 10 to three (3) pyrolysis tubes 44. It may be desirable to use a single conveyor 26 and a distribution manifold 82 to convey feedstock 10 to multiple pyrolysis streams 15, as such a configuration can be less capital intensive and less complicated, requiring only one first stage auger 36 and drive mechanism 34, while still providing the heating (i.e. surface area) advantage of using multiple pyrolysis tubes 44.

### Series Connection

In another embodiment, with reference to FIG. 2B, two or more pyrolysis tubes 44 can be connected together in series such that any remaining feedstock 10 exiting from an upstream pyrolysis tube 44 will be conveyed to an adjacent downstream pyrolysis tube 44 for further pyrolysis. Each pyrolysis tube 44 in a series can have a different feed rate relative to the other pyrolysis tubes 44 of the series, or can have the same feed rate. The speed and/or rate at which feedstock 10 travels through each pyrolysis tube 44 of a series may be increased or decreased as required, such as by varying the scroll pitch angle of the second stage augers 38 of the pyrolysis tubes 44, or modifying the pyrolysis tube 44 diameter. Each pyrolysis tube 44 may be heated to a different temperature in order to achieve more complete pyrolysis of the feedstock 10. For example, in embodiments using induction coils 70, one or more induction coils 70 corresponding to each pyrolysis tube 44 of a series can be operated to heat the pyrolysis tubes 44 to a different temperature. Having multiple pyrolysis tubes 44 in series, multiple gas conduits 60 installed at the outlet end of each pyrolysis tube 44 can draw off gases produced by the pyrolysis process in stages before the remaining feedstock 10 is conveyed into the next pyrolysis tube 44. The second stage auger 38 could be extended as required to convey the feedstock 10 through each pyrolysis tube 44 in the series. The auger 38 can also be designed to consolidate the feedstock 10 leaving a pyrolysis tube 44 of the series prior to entering the inlet of a subsequent downstream pyrolysis tube 44, thereby creating a seal to prevent the gases produced in adjacent pyrolysis tubes 44 from mixing. For example, the auger scrolling of an upstream pyrolysis tube 44 can terminate before reaching the inlet nozzle of a subsequent pyrolysis tube 44. This will cause the feedstock 10 to accumulate at this location and be compressed by the incoming feedstock 10 being conveyed thereto by the upstream auger, thereby forming a seal between the adjacent pyrolysis tubes 44. In embodiments, some or all of the pyrolysis tubes 44 can also have radial constrictions/nozzles 40 at their outlet ends to further assist in consolidating feedstock 10 prior to entering a downstream pyrolysis tube 44. The radial constrictions/nozzles 40 can be temporary reductions in the radius of the bore of the pyrolysis tube 44, or can be permanent reductions in radius, such that the adjacent downstream pyrolysis tube 44 has a smaller diameter bore than the upstream pyrolysis tube 44.

### Auger Configurations

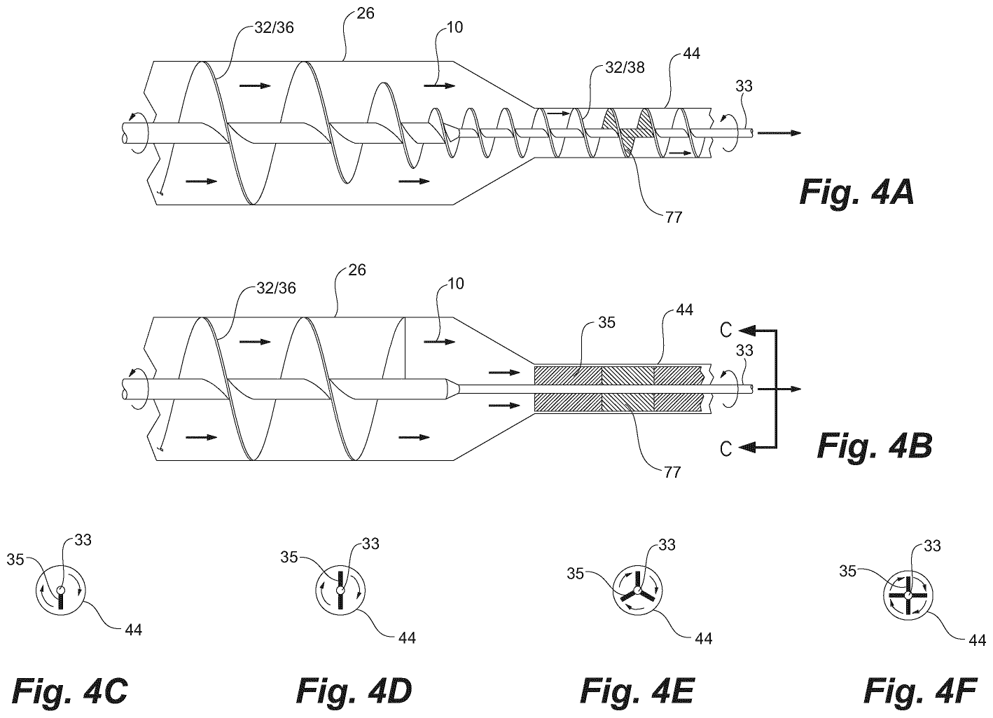

FIGS. 4A-4F show alternative configurations of the first and second stage augers 36,38. FIG. 4A shows a first stage auger 36 in which the outside diameter and pitch of the spiral scroll diminishes as it approaches the radial constriction/nozzle 40 of the conveyor 26 until it can fit into the downstream pyrolysis tube 44, which has a smaller inner diameter than the conveyor 26. In such embodiments, the first stage auger 36 and second stage auger 38 are continuous. In embodiments, a central shaft 33 of the first stage auger 36 also diminishes as it enters the pyrolysis tube 44 to provide more space for feedstock 10 therein.

With reference to FIG. 4B, in an alternative embodiment, the spiral scroll of the first stage auger 36 has a constant outside diameter and pitch and terminates at a point upstream of the radial constriction/nozzle 40. Once again, the diameter of the central shaft 33 of the auger 36 can narrow as it approaches the downstream pyrolysis tube 44. This portion of the central shaft 33 may remain as a plain rod, support the second stage auger 38, or may incorporate a number of vanes 35 that may travel the entire length of the shaft 33. As the shaft 33 is attached to the auger drive mechanism 34, it will rotate with the first stage auger 36. In this instance, the vanes 35 provide a sweeping motion as the feedstock 10 travels along the pyrolysis tube 44, spreading out the feedstock 10 over the circumference of the inner surface of the pyrolysis tube 44 and not allowing the feedstock 10 to collect at a bottom portion of the pyrolysis tube 44. Such spreading of the feedstock 10 provides more even heat transfer thereto during the pyrolysis process. FIGS. 4C-4F show various configurations of the vanes 35, in particular FIGS. 4C-4F depict shafts 33 with one, two, three, and four vanes 35, respectively. As such embodiments incorporating vanes 35 do not have an auger to convey feedstock 10 through the pyrolysis section 14, feedstock 10 is instead displaced through the pyrolysis tube 44 by new feedstock 10 being delivered into the pyrolysis tube 44 by the first stage auger 36. Alternatively, the entire pyrolysis system 2 and/or or the pyrolysis tubes 44, may be sloped downward toward the outlet section 16 to cause the feedstock 10 and any debris to migrate toward outlet section 16 with each passing of a vane 35.

In some embodiments, the second stage augers 38 or vanes 35 can have ceramic insulator segments 77 juxtaposed to the thermal/magnetic insulators 74 that may be placed along the pyrolysis tube 44, such that segments of the second stage augers 38 or vanes 35 are thermally and magnetically isolated and can be heated up to different temperatures by corresponding induction coils 70.

### Operation

With reference to the exemplary embodiment shown in FIG. 1, the pyrolysis process commences as the feedstock 10 is broken up in shredding hopper 22 and fed into the feed hopper 18. A feeding mechanism 20, in the form of an auger, is located in the feed hopper 18 to consolidate and force feedstock 10 into the conveyor 26. The first stage auger 36 located in the conveyor 26 transports feedstock 10 therein into the pyrolysis section 14, in this embodiment comprising a single pyrolysis tube 44. Once in the pyrolysis section 14, the feedstock 10 draws heat from the pyrolysis tube 44, which is in turn heated by molten metal heat exchange medium 50 in contact therewith and housed inside heat exchange/bath chamber 38. The pyrolysis tube 44 acts as a miniature kiln and pyrolysis occurs on a continuous basis as feedstock 10 is transported into the pyrolysis tube 44 by the first stage auger 36 and the second stage auger 38 conveys the feedstock 10 through the pyrolysis tube 44. Pyrolysis products, such as condensable and non-condensable gases G and solid reside S, are conveyed to the outlet section 16. In embodiments without a second stage auger 38, feedstock 10 is displaced through the pyrolysis tube 44 by feedstock 10 entering therein from the feed section 12. The length and diameter of the pyrolysis tubes 44 can be designed to ensure that the pyrolysis of the feedstock 10 is completed prior to exiting the pyrolysis tube 44. The condensable and non-condensable gases G and any solid residue S (i.e. char, steel belting, etc.), produced during pyrolysis exit via the outlet end of the pyrolysis tubes 44 and do not come into direct contact with the molten metal heat exchange medium 50 of the heat exchanger 47, thereby avoiding contamination thereof and the need to periodically clean the heat exchange/bath chamber 48 of residue. The particulate residue S generated by pyrolysis can be displaced out the outlet of the pyrolysis tube 44 as additional feedstock 10 is introduced therein, or can be conveyed out of the pyrolysis tube 44 by the respective second stage auger 38. The residue S then drops into collection chamber 66 in the solids collection portion 62 where it accumulates until removed via solids removal valve 64. The particulate residue S may then be further processed utilizing typical processing equipment so that it too can be recycled or disposed of. The condensable and non-condensable gases G are directed via the gas conduit 60 to downstream processing equipment (e.g. cyclone separators, condensers, etc.) used for producing valuable products from these gases, such as low-sulphur gasoline, diesel and synthetic gas.

In this embodiment, heat transfer is taking place between the molten metal heat exchange medium 50, pyrolysis tube 44 walls, and the feedstock 10 therein. Confining the feedstock 10 within pyrolysis tubes 44 for the entirety of the pyrolysis process provides an efficient method of transporting the feedstock 10 through the pyrolysis system 2, prevents contamination of the molten metal heat exchange medium 50 with feedstock/pyrolysis products and vice versa, and allows for the produced gases G and any residual solid material S to be transported through the pyrolysis section 14 on a continuous basis.

This technology is an improvement on conventional technology in that it allows for the continuous introduction of feedstock 10 into the pyrolysis system 2 and the removal of any particulate residue S that could remain after pyrolysis. The large surface-area-to-cross-sectional-area ratio provided by using multiple small-diameter pyrolysis tubes 44 permits more efficient heat transfer to the feedstock 10 relative to existing pyrolysis technologies, which expedites the pyrolysis process and thus increases throughput capacity.

Immaterial modifications may be made to the embodiments described herein without departing from the scope of the invention. The word “comprising” is used in its inclusive sense and does not exclude other elements being present. The indefinite article “a” before a component does not exclude more than one of the features being present. Each one of the individual features described herein may be used in one or more embodiments and is not, by virtue only of being described here, to be construed as essential to all embodiments as defined by the claims.

1. A pyrolysis system for the continuous pyrolysis of feedstock and removal of products of the pyrolysis of feedstock to downstream equipment, comprising:
one or more pyrolysis tubes configured to receive feedstock from one or more conveyors;
heating means for heating the one or more pyrolysis tubes and pyrolyzing the feedstock therein; and
an outlet section for receiving and directing the products of pyrolysis to the downstream equipment;
wherein the pyrolysis tubes are substantially enclosed to prevent the feedstock and products of pyrolysis from leaving the pyrolysis tubes except via the outlet section.

2. The pyrolysis system of claim 1, wherein the one or more conveyors each have a first stage auger extending therethrough and operatively connected to a first drive mechanism configured to rotate the first stage auger for conveying the feedstock towards the one or more pyrolysis tubes.

3. The pyrolysis system of claim 1, further comprising one or more second stage augers extending through a respective one of the one or more pyrolysis tubes and operatively connected to a respective second drive mechanism configured to rotate the second stage auger for conveying the feedstock through the one or more pyrolysis tubes towards the outlet section.

4. The pyrolysis system of claim 1, wherein the one or more conveyors each comprise a radial constriction located towards an outlet end of the one or more conveyors for consolidating the feedstock and forcing air and water out therefrom.

5. The pyrolysis system of claim 1, wherein:
the heating means comprises a heat exchanger having a heat exchange medium stored in a heat exchange chamber;
one or more heat sources are configured to heat the heat exchange medium; and
the one or more pyrolysis tubes are at least partially immersed in the heat exchange medium for receiving heat therefrom.

6. The pyrolysis system of claim 1, wherein:
the one or more pyrolysis tubes are made at least partially of a ferromagnetic material; and
the heating means comprises one or more induction coils wrapped around each of the one or more pyrolysis tubes and operatively connected to at least one AC power source configured to deliver a driving alternating current thereto for heating the one or more induction coils.

7. The pyrolysis system of claim 1, wherein the outlet section comprises a gas conduit for receiving gases of the products of pyrolysis and a solids collection portion for receiving solid residue of the products of pyrolysis.

8. The pyrolysis system of claim 7, wherein:
the gas conduit comprises a one-way valve for permitting gases of the products of pyrolysis to exit the pyrolysis system while maintaining the substantially inert environment of the pyrolysis section; and
the solids collection portion comprises a solids removal valve for permitting the solid residue to be removed while maintaining the substantially inert environment of the pyrolysis section.

9. A pyrolysis apparatus for the continuous pyrolysis of feedstock and removal of products of the pyrolysis of feedstock to an outlet section, comprising:
one or more pyrolysis tubes configured to receive feedstock at an inlet end and direct the products of pyrolysis to the outlet section via an outlet end; and
heating means for heating the one or more pyrolysis tubes and pyrolyzing the feedstock therein;
wherein the pyrolysis tubes are substantially enclosed except at the inlet end and outlet end.

10. The pyrolysis system of claim 9, wherein:
the heating means comprises a heat exchanger having a heat exchange medium stored in a heat exchange chamber;
one or more heat sources are configured to heat the heat exchange medium; and
the one or more pyrolysis tubes are at least partially immersed in the heat exchange medium for receiving heat therefrom.

11. The pyrolysis system of claim 10, wherein the heat exchange medium is a molten metal.

12. The pyrolysis system of claim 11, further comprising an inert gas stored in the heat exchange chamber for mitigating oxidation of the molten metal.

13. The pyrolysis system of claim 9, wherein:
the one or more pyrolysis tubes are made at least partially of a ferromagnetic material;
the heating means comprises one or more induction coils wrapped around each of the one or more pyrolysis tubes and operatively connected to at least one AC power source configured to deliver a driving alternating current thereto for inductive heating of the one or more induction coils.

14. The pyrolysis system of claim 13, wherein each of the one or more pyrolysis tubes have at least two induction coils of the one or more induction coils wrapped therearound, and each of the at least two induction coils are connected to a respective AC power source.

15. The pyrolysis system of claim 14, wherein each of the at least two pyrolysis tubes are axially separated by a thermal and magnetic insulator.

16. A method of continuously pyrolyzing feedstock and directing products of the pyrolysis of feedstock to an outlet section, comprising:
receiving feedstock in one or more pyrolysis tubes;
preventing the feedstock and products of pyrolysis from leaving the pyrolysis tubes except via the outlet section; and
heating the one or more pyrolysis tubes to within a desired temperature range, for the feedstock, for pyrolyzing the feedstock therein.

17. The method of claim 16, further comprising permitting gases of the product of pyrolysis to exit via a gas conduit of the outlet section while preventing air and moisture from entering into the one or more pyrolysis tubes.

18. The method of claim 16, further comprising removing solid residue of the products of pyrolysis from the outlet section while preventing air and moisture from entering into the one or more pyrolysis tubes.

19. The method of claim 16, further comprising compressing the feedstock to form a plug upstream of the one or more pyrolysis tubes for preventing air and moisture from entering into the one or more pyrolysis tubes.

20. The method of claim 16, further comprising heating axial segments of each of the one or more pyrolysis tubes to a different temperature.
